(19) United States
(12) Patent Application Publication
(10) Pub. No.: US 2019/0049746 A1
(43) Pub. Date: Feb. 14, 2019

(54) SELF-ALIGNING CONNECTOR FOR EYE WEAR STRAP

(71) Applicant: Richard Warren Steele, Belleair Bluffs, FL (US)

(72) Inventor: Richard Warren Steele, Belleair Bluffs, FL (US)

(21) Appl. No.: 16/155,246

(22) Filed: Oct. 9, 2018

Related U.S. Application Data
(60) Provisional application No. 62/543,727, filed on Aug. 10, 2017.

(51) Int. Cl. G02C 3/00

(52) U.S. Cl. CPC G02C 3/006; G02C 2200/02

(57) ABSTRACT

A strap attachment for eye wear including a strap having a first end opposite a second end. A first connector is coupled to the first end of the strap and a second connector is coupled to the second end of the strap. Each of the first connector and the second connector include a magnetic material. A first receiver and a second receiver are each configured to fit over a right side arm and a left side arm of eye wear glasses. Each of the first receiver and the second receiver include a magnetic material that is attracted to the magnetic material of the first connector and the second connector.

### CROSS-REFERENCE TO RELATED APPLICATION

This application claims the benefit of priority of U.S. provisional application No. 62/543,727, filed Aug. 10, 2017, the contents of which are herein incorporated by reference.

### BACKGROUND OF THE INVENTION

The present invention relates to eye wear straps and, more particularly, to self-aligning connector for an eye wear strap.

Eye-wear straps are typically permanently affixed to each individual pair of eye-wear glasses frame arms. For eye-wear users, it is difficult and cumbersome switching back and forth between outdoor sunglasses and indoor clear eyeglasses multiple times each day, day after day. Each pair requires their own strap and this can add to user frustration when storing the unused pair between uses. Additionally, permanently mounted strap/cord systems on glasses are difficult to store in glasses cases and become entangled.

As can be seen, there is a need for a self-aligning connector for an eye wear strap.

### SUMMARY OF THE INVENTION

In one aspect of the present invention, a strap attachment for eye wear comprises: a strap comprising a first end and a second end; a first connector coupled to the first end of the strap and a second connector coupled to the second end of the strap, wherein each of the first and second connectors comprise a magnetic material; and a first receiver and a second receiver each configured to fit over an arm of eye wear glasses, and each comprising a magnetic material, wherein the magnetic materials of the first connector and the second connector are attracted to the magnetic materials of the first receiver and the second receiver.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention in use;

FIG. 2 is a detail perspective view of an embodiment of the present invention;

FIG. 3A is a right-hand side detail exploded view of an embodiment of the present invention;

FIG. 3B is a left-hand side detail perspective view of an embodiment of the present invention;

FIG. 4 is a section view of the present invention, taken along line 4-4 in FIG. 2;

FIG. 5 is a perspective view of an embodiment of the present invention

FIG. 6 is a section view of the present invention, taken along line 6-6 in FIG. 5;

FIG. 7 is a perspective view of an alternate use of an embodiment of the present invention;

FIG. 8 is a detail perspective view of an alternate use of an embodiment of the present invention;

FIG. 9 is a detail perspective view of an embodiment of the present invention;

FIG. 10 is a section view of the present invention, taken along line 10-10 in FIG. 9;

FIG. 11 is a side view of an embodiment of the present invention in use; and

FIG. 12 is a section view of the present invention, taken along line 12-12 in FIG. 11.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a self-aligning interchanging eye-wear keeper system utilizing magnets with necklace pendants and ornamental jewelry features. The design of the present invention makes switching between two or more different pairs of eye-wear glasses effortless by having only one single common cord/strap that works for all the pairs of eye-wear glasses utilizing a self-aligning feature making it effortless to switch between many different pairs. This is accomplished by precisely positioning magnets and integrating them with self-aligning shapes where mating magnets are positioned. Also, the user is not required to visually see the self-aligning mechanism to make it function which is unique to this design. In addition, the two strap ends with magnets create a holding clasp that may be used for hanging ornamental jewelry around the users neck.

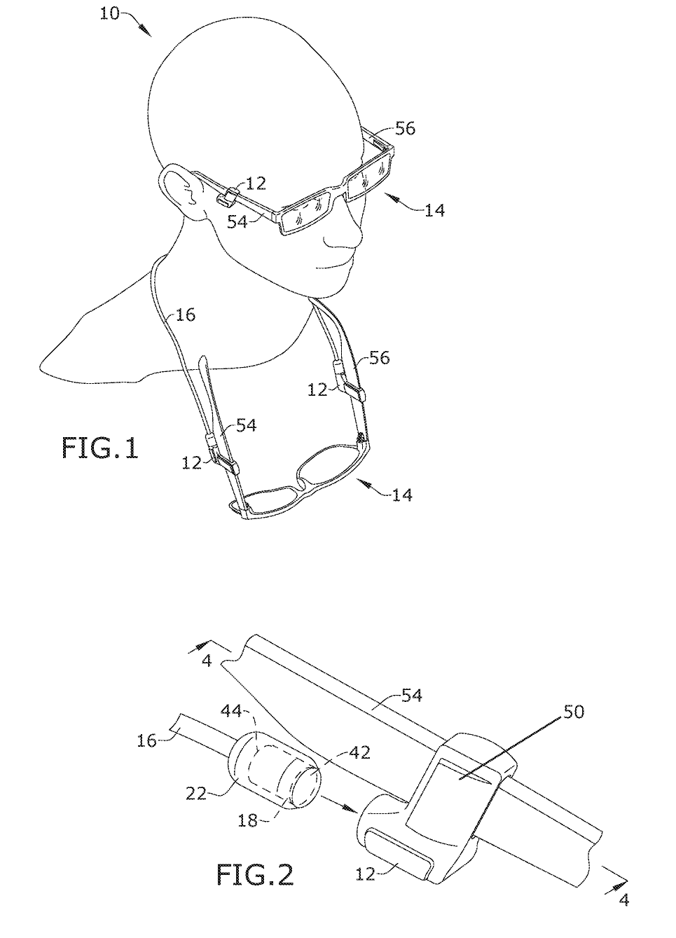

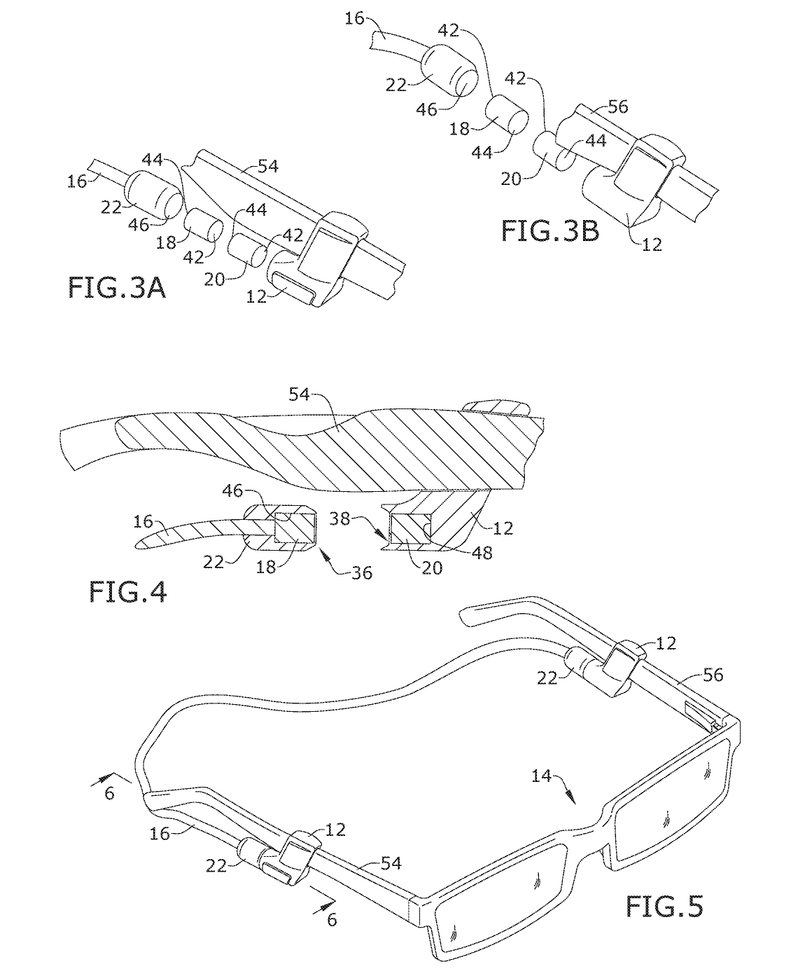

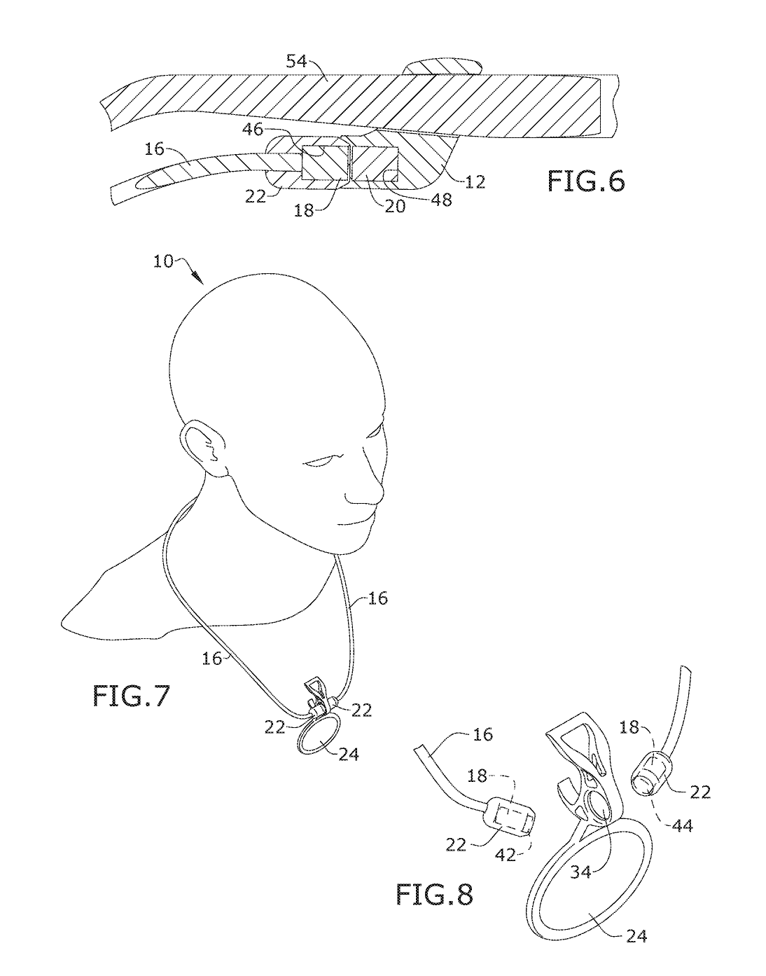

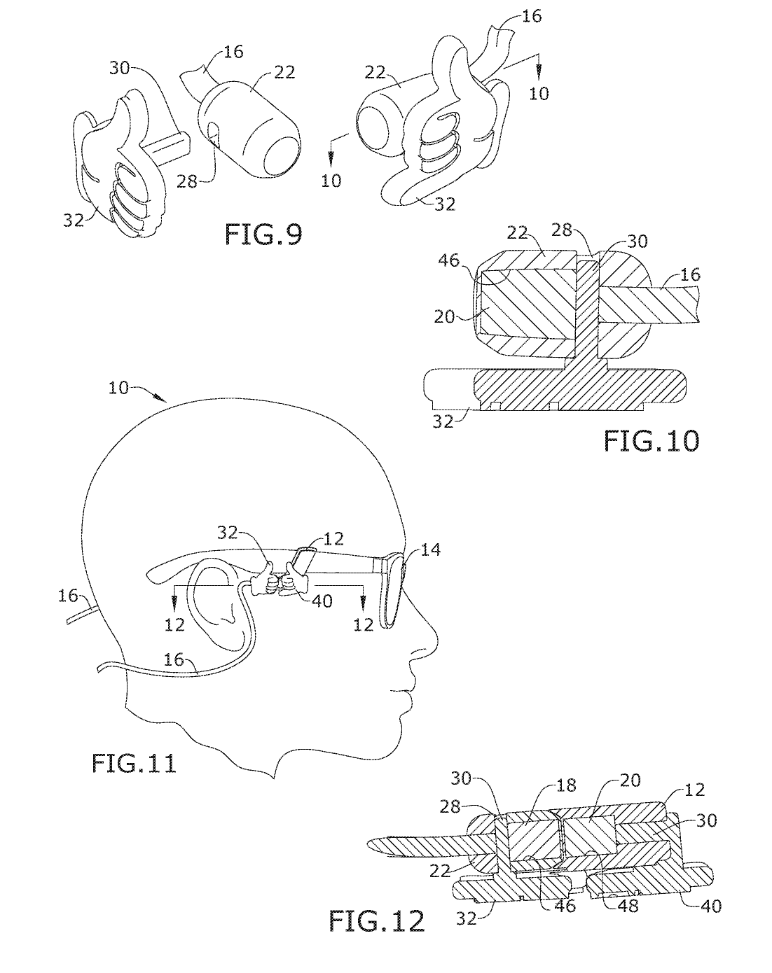

Referring to FIGS. 1 through 12, the present invention includes a strap attachment for eye wear 14. A strap 16 includes a first end opposite a second end. A first connector 22 is coupled to the first end of the strap 16 and a second connector 22 is coupled to the second end of the strap 16. Each of the first connector 22 and the second connector 22 include a magnetic material 18. A first receiver 12 and a second receiver 12 are each configured to fit over a right side arm 54 and a left side arm 56 of eye wear glasses 14. Each of the first receiver 12 and the second receiver 12 include a magnetic material 20 that is attracted to the magnetic material 18 of the first connector 22 and the second connector 22.

In certain embodiments, the first and second eyewear receivers 12 each include looped bodies 50 defining internal slots. The arms 54, 56 of the eye wear glasses 14 snugly fit within the internal slots. Each of the first and second eye wear receivers 12 further include a magnet slot 48. The magnetic material 20 is disposed within the magnet slot 48. The magnetic material 20 may each include magnets having a positive polarity 42 and a negative polarity 44.

As mentioned above, the first and second connectors 22 are coupled to opposing ends of the strap 16. Each of the first and second connectors 22 includes a magnet slot 46. The magnetic material 18 is disposed within the magnet slot 46. The magnetic material 18 may each include magnets having a positive polarity 42 and a negative polarity 44. The positive polarity 42 and the negative polarity 44 of the magnetic material of the connectors 22 and the receivers 12 face one another, and thereby releasably attach by the magnetic attraction. The magnetic materials 18, 20 may include neodymium magnets.

In certain embodiments, the first receiver 12 and the second receiver 12 each include a tapered flair 38 disposed circumferentially around an end. In such embodiments, each of the first connector 22 and the second connector 22 include a beveled edge 36. The beveled edge 36 forms a male guide and the tapered flair 38 forms a female guide. The beveled edge 36 and the tapered flair 38 guide the connectors 22 and the receivers 12 together.

In certain embodiments, the present invention may include decorative attachments 32. The decorative attachments 32 may include a decoration and a post 30 extending therefrom. In such embodiments, each of the receivers 12 and the connectors 22 include a post opening 28. The post 30 of the decorative attachment 32 fits within the post opening 28, thereby releasably securing the decorative attachment 32 to either the receiver 12 or the connector 22.

The present invention may further include a pendant 24. The pendant 24 may include a receiver slot 34. In such embodiments, the present invention may be used as a necklace. For example, the first connector 22 and the second connector 22 may connect together within the receiving slot 34 and the strap 16 may be worn around a user's 10 neck.

The eye wear retainer system may utilize a single strap 16 for one or more pairs of glasses 14 and the user does not have to visually see it to make it work. This unique design integrates specific high-powered magnets. With varying directional polarity placements of the magnets together, a unique environment creating a self-locating feature is enabled. It is very easy to switch between multiple pairs of eye-wear glasses 14. Additionally, by using the same magnets used within the strap 16, this design incorporates two additional options for jewelry ornaments and pendant 24 features. These options allow greater personalization and creativity for each user to customize and complement their own unique style for using the present invention.

It should be understood, of course, that the foregoing relates to exemplary embodiments of the invention and that modifications may be made without departing from the spirit and scope of the invention as set forth in the following claims.

What is claimed is:

1. A strap attachment for eye wear comprising:
a strap comprising a first end and a second end;
a first connector coupled to the first end of the strap and a second connector coupled to the second end of the strap, wherein each of the first and second connectors comprise a magnetic material; and
a first receiver and a second receiver each configured to fit over an arm of eye wear glasses, and each comprising a magnetic material, wherein
the magnetic materials of the first connector and the second connector are attracted to the magnetic materials of the first receiver and the second receiver.

2. The strap attachment for eye wear of claim 1, wherein each of the first connector, the second connector, the first receiver, and the second receiver comprise a self-locating post receiver.

3. The strap attachment for eye wear of claim 2, further comprising a plurality of decoration attachments each comprising a post that releasably fits into the post receivers.

4. The strap attachment for eye wear of claim 1, wherein each of the first receiver and the second receiver comprise a tapered flair disposed circumferentially around an end, and each of the first connector and the second connector comprise a beveled edge, wherein the beveled edge and the tapered flair guide the connectors and the receivers together.

5. The strap attachment for eye wear of claim 1, wherein the magnetic materials are magnets.

6. The strap attachment for eye wear of claim 1, wherein the first receiver and the second receiver each comprise looped bodies defining internal slots, wherein the arms of the eye wear glasses snugly fit within the internal slots.

7. The strap attachment for eye wear of claim 1, further comprising a pendant having an receiving slot, wherein the magnetic materials of the first connector and the second connector connect together within at the receiving slot.
